(19) United States
(12) Patent Application Publication
(10) Pub. No.: US 2017/0153842 A1
(43) Pub. Date: Jun. 1, 2017

(54) DATA ALLOCATION IN HARD DRIVES

(71) Applicant: HGST Netherlands B.V., Amsterdam (NL)

(72) Inventor: Masato Iwabuchi, Tokyo (JP)

(21) Appl. No.: 14/955,744

(22) Filed: Dec. 1, 2015

(51) Int. Cl. G06F 3/06; G11B 20/12; G06F 12/10

(52) U.S. Cl. CPC G06F 3/0644; G06F 3/061; G06F 3/0643; G06F 3/0676; G06F 12/1009; G11B 20/1217; G11B 2020/1238; G11B 2020/1242; G11B 2020/1292

(57) ABSTRACT

In one example, the disclosure is directed to a method comprising receiving, by a controller of a hard disk drive, a request to write a data block to a data storage platter of the hard disk drive. The data storage platter of the hard disk drive includes at least one random access zone and at least one sequential access zone. The controller determines a hinting value for the data block based on hinting information of the data block. The controller further determines, based at least in part on the hinting value, a location of the data storage platter of the hard disk at which to write the data block. The location includes one of the at least one random access zone or one of the at least one sequential access zone. The controller writes the data block at the location.

### TECHNICAL FIELD

The disclosure relates to shingled magnetic recording hard disk drives.

### BACKGROUND

Shingled magnetic recording (SMR) hard disk drives (HDDs) are organized using physical regions to which a hard drive controller can write data. Among SMD HDDs, there exist three different types of management techniques for handling writes to the SMR HDD—drive managed, host managed, and host aware. In a drive managed SMR HDD environment, the drive handles all requests from the host using the SMR HDD itself, but performance is unpredictable as the SMR HDD handles background processes when needed, without any consideration of pending input/output (IO) requests. Additionally, because inbound random writes are not coalesced into sequential writes on the host side, the SMR HDD is required to perform more operations, increasing the load on the SMR HDD and lowering performance in sustained workloads.

In a host managed SMR HDD environment, a host uses commands and zone information to optimize the behavior of the SMR HDD by managing IO requests to ensure writes are always sequential within a zone. However, in order to utilize a host managed SMR HDD, the host system, such as a host bus adapter, a device driver, a file system, or a database, for instance, must be SMR aware. If the host system is not configured to specifically support an SMR HDD, the system may fail. Lastly, in a host aware SMR HDD environment, the SMR HDD manages the IO requests by default, but a host configured to support an SMR HDD may send specific requests. However, implementation of the complexities involved with host aware SMR HDDs may increase costs of producing such drives. Further, if the host sends a sub-optimal request that the SMR HDD accepts, the request may be carried out in an unpredictable manner.

### SUMMARY

In one example, the disclosure is directed to a method comprising receiving, by a controller of a hard disk drive, a request to write a data block to a data storage platter of the hard disk drive. The data storage platter of the hard disk drive includes at least one random access zone and at least one sequential access zone. The controller determines a hinting value for the data block based on hinting information of the data block. The controller further determines, based at least in part on the hinting value, a location of the data storage platter of the hard disk at which to write the data block. The location includes one of the at least one random access zone or one of the at least one sequential access zone. The controller writes the data block at the location.

In another example, the disclosure is directed to a hard disk drive comprising a data storage platter including at least one random access zone and at least one sequential access zone. The hard disk drive further comprises a controller. The controller is configured to receive a request to write a data block to the data storage platter of the hard disk drive. The controller is also configured to determine, based on hinting information of the data block, a hinting value for the data block. The controller is also configured to determine, based at least in part on the hinting value, a location of the data storage platter of the hard disk drive at which to write the data block. The location includes one of the at least one random access zone or one of the at least one sequential access zone. The controller is further configured to write the data block at the location.

In another example, the disclosure is directed to a computer-readable medium containing instructions. The instructions cause a controller of a hard disk drive to receive a request to write a data block to a data storage platter of the hard disk drive. The data storage platter includes at least one random access zone and at least one sequential access zone. The instructions also cause the controller to determine, based on hinting information of the data block, a hinting value for the data block. The instructions also cause the controller to determine, based at least in part on the hinting value, a location of the data storage platter of the hard disk drive at which to write the data block. The location includes one of the at least one random access zone or one of the at least one sequential access zone. The instructions further cause the controller to write the data block to one of a random access zone or a sequential access zone based at least in part on the hinting value.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual and schematic block diagram illustrating an example storage environment in which a hard drive may function as a storage device for a host device, in accordance with one or more techniques of this disclosure.

FIG. 2 is a block diagram illustrating the controller and other components of the hard drive of FIG. 1 in more detail.

FIG. 3 is a conceptual diagram illustrating an example addition to a data block to be written to the hard drive, in accordance with one or more techniques of this disclosure.

FIG. 4 is a conceptual and schematic block diagram illustrating an example layer system of the hard drive, in accordance with one or more techniques of this disclosure.

FIG. 5 is a flow diagram illustrating an exemplary operation of a storage device controller in performing various aspects of the data allocation techniques described in this disclosure.

### DETAILED DESCRIPTION

In general, this disclosure describes techniques for allocating data in a host managed or host aware shingled magnetic recording (SMR) hard disk drive (HDD) using hinting bits, which may minimize host-side program modification while providing a predictable and universal method for writing data blocks in a host managed or host aware SMR HDD. These techniques may provide the benefit of predictable operations, rather than the unpredictable nature of drive managed SMR HDDs and host aware SMR HDDs that may write data to sub-optimal portions of the SMR HDD. As such, an SMR HDD may be configured to allocate data based on how frequently the data is modified or how often the data is predicted to be modified. The predictability arises from dividing the SMR HDD into random access zones and sequential access zones and allocating the data into one of the two types of zones. For examples, frequently modified data may be more efficiently accessed and written in a random access zone than in an SMR zone. Conversely, larger blocks of data and media files may be more efficiently accessed and written in a sequential access zone rather than a random access zone. Further, by minimizing modifications required of host systems and host applications, a host system that is not SMR aware may utilize an interface that executes the techniques described herein to allow legacy systems to utilize SMR HDDs.

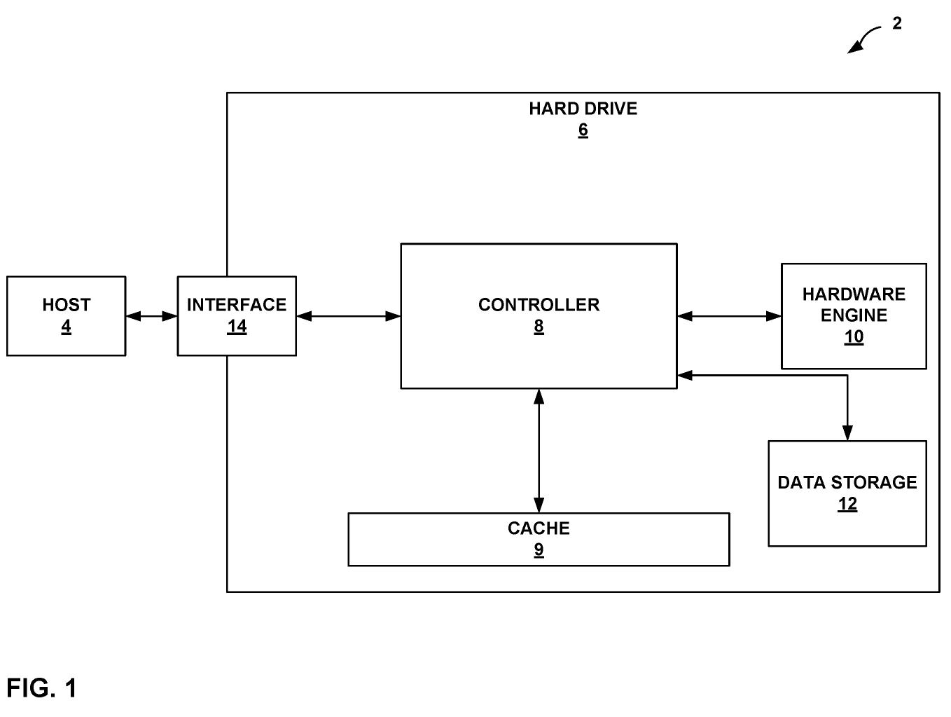

FIG. 1 is a conceptual and schematic block diagram illustrating an example storage environment 2 in which hard drive 6 may function as a storage device for host device 4, in accordance with one or more techniques of this disclosure. For instance, host device 4 may utilize non-volatile memory devices included in hard drive 6 to store and retrieve data. In some examples, storage environment 2 may include a plurality of storage devices, such as hard drive 6, which may operate as a storage array. For instance, storage environment 2 may include a plurality of hard drives 6 configured as a redundant array of inexpensive/independent disks (RAID) that collectively function as a mass storage device for host device 4. While techniques of this disclosure generally refer to storage environment 2 and hard drive 6, techniques described herein may be performed in any storage environment that utilizes tracks of data.

Storage environment 2 may include host device 4 which may store and/or retrieve data to and/or from one or more storage devices, such as hard drive 6. As illustrated in FIG. 1, host device 4 may communicate with hard drive 6 via interface 14. Host device 4 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like. Typically, host device 4 comprises any device having a processing unit, which may refer to any form of hardware capable of processing data and may include a general purpose processing unit (such as a central processing unit (CPU), dedicated hardware (such as an application specific integrated circuit (ASIC)), configurable hardware such as a field programmable gate array (FPGA) or any other form of processing unit configured by way of software instructions, microcode, firmware or the like.

As illustrated in FIG. 1 hard drive 6 may include a controller 8, a cache 9, a hardware engine 10, data storage device 12, and an interface 14. In some examples, hard drive 6 may include additional components not shown in FIG. 1 for ease of illustration purposes. For example, hard drive 6 may include power delivery components, including, for example, a capacitor, super capacitor, or battery; a printed board (PB) to which components of hard drive 6 are mechanically attached and which includes electrically conductive traces that electrically interconnect components of hard drive 6, and the like. In some examples, the physical dimensions and connector configurations of hard drive 6 may conform to one or more standard form factors. Some example standard form factors include, but are not limited to, 3.5″ hard disk drive (HDD), 2.5″ HDD, or 1.8″ HDD.

In some examples, cache 9 may store information for processing during operation of hard drive 6. In some examples, cache 9 is a temporary memory, meaning that a primary purpose of cache 9 is not long-term storage. Cache 9 on hard drive 6 may configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

In some examples, hard drive 6 may be an SMR hard drive. With SMR, relatively wide tracks are written to hard drive 6 and successively written data tracks partially overlap the previously written data tracks, which typically increases the density of hard drive 6 by packing the tracks closer together. When energized, a magnetic field emanating from the poles writes and erases data by flipping the magnetization of small regions, called bits, on spinning platters, such as data storage 12, directly below. Hard drive 6 may also include portions that are configured to store data with random access. To accommodate the random access zones, portions of hard drive 6 may have tracks spaced farther apart than in the sequential, SMR zone.

Data storage 12 may be configured to store larger amounts of information than cache 9. Data storage 12 may further be configured for long-term storage of information as non-volatile memory space and retain information after power on/off cycles. Examples of non-volatile memories include magnetic hard disks, optical disks, floppy disks, flash memories, or forms of electrically programmable memories (EPROM) or electrically erasable and programmable memories (EEPROM). Data storage 12 may be one or more magnetic platters in hard drive 6, each platter containing one or more regions of one or more tracks of data.

Hard drive 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: advanced technology attachment (ATA) (e.g., serial-ATA (SATA), and parallel-ATA (PATA)), Fibre Channel, small computer system interface (SCSI), serially attached SCSI (SAS), peripheral component interconnect (PCI), and PCI-express (PCIe). The electrical connection of interface 14 (e.g., the data bus, the control bus, or both) is electrically connected to controller 8, providing electrical connection between host device 4 and controller 8, allowing data to be exchanged between host device 4 and controller 8. In some examples, the electrical connection of interface 14 may also permit hard drive 6 to receive power from host device 4.

In the example of FIG. 1, hard drive 6 includes hardware engine 10, which may represent the hardware responsible for interfacing with the storage medium. Hardware engine 10 may, in the context of a platter-based hard drive, represent the magnetic read/write head and the accompanying hardware to configure, drive and process the signals sensed by the magnetic read/write head.

Hard drive 6 includes controller 8, which may manage one or more operations of hard drive 6. Controller 8 may interface with host device 4 via interface 14 and manage the storage of data to and the retrieval of data from data storage 12 accessible via hardware engine 10. Controller 8 may, as one example, manage writes to and reads from the memory devices, e.g., Negated AND (NAND) flash memory chips or a hard disk drive platter. In some examples, controller 8 may be a hardware controller. In other examples, controller 8 may be implemented into hard drive 6 as a software controller. Controller 8 may further include one or more features that may perform techniques of this disclosure, such as atomic write-in-place module 16.

Host 4 may, in this respect, interface with various hardware engines, such as hardware engine 10, to interact with various sensors. Host 4 may execute software, such as the above noted operating system, to manage interactions between host 4 and hardware engine 10. The operating system may perform arbitration in the context of multi-core CPUs, where each core effectively represents a different CPU, to determine which of the CPUs may access hardware engine 10. The operating system may also perform queue management within the context of a single CPU to address how various events, such as read and write requests in the example of hard drive 6, issued by host 4 should be processed by hardware engine 10 of hard drive 6. In accordance with techniques of this disclosure, host 4 may or may not be SMR aware. Since techniques of this disclosure are executed in controller 8 of hard drive 6, host 4 need not be SMR aware or configured to execute SMR commands.

In accordance with the techniques of this disclosure, hard drive 6 may be configured to allocate data based on how frequently the data is modified or how often the data is predicted to be modified. For instance, data storage 12 may include at least one random access zone and at least one sequential access zone. In a random access zone, controller 8 may read or write information anywhere in the zone. Further, writing data in one track adjacent to another track in the random access zone does not overwrite the adjacent track, unlike in the sequential access zone. In a sequential access zone, controller 8 may read and write information sequentially at the end of the last write. However, when data is erased or overwritten, controller 8 may re-write the entirety of the track that contained the erased or overwritten data in the sequential access zone. As such, it may be inefficient to place frequently modified data in a sequential access zone. If information is not accessed frequently, then reading and writing the information in a sequential access zone is faster and more space efficient. If the information is accessed more frequently, then storing the information in a random access zone leads to faster and more efficient read and write operations, as adjacent tracks are not overwritten when the data is accessed.

In general, data storage 12 platter of hard drive 6 may contain a plurality of physical regions. A physical region is an area of contiguous, overlapping magnetic tracks that are parallel to one another. Each physical region may be separated by a guard band, which is a set of one or more magnetic tracks that do not store data. Logical block addresses may be a logical interpretation of a location of a physical region on hard drive 6. Each region may be polymorphic, in that each region can have arbitrary attributes.

In some examples where hard drive 6 is an SMR hard drive, data storage 12 may comprise two at least two specific types of regions: I-regions and E-regions. Tracks on a disk surface may be organized into a plurality of shingled regions, called I-regions. The direction of the shingled writing for an I-region can be from an inner diameter (ID) to an outer diameter (OD) or from OD to ID. The disk may also be shingled in both directions on the same surface, with the two zones meeting approximately at the mid-diameter point. The write performance of hard drive 6 correlates with the number of tracks grouped together in each region such that, as the number of tracks increases, the write performance of hard disk 6 may decrease when the writes are random or smaller than the size of the grouped tracks. Once written in the shingled structure, an individual track may not be able to be updated in place because re-writing the track in place may overwrite and destroy the data in the overlapping tracks.

In an attempt to improve the performance of SMR drives, a portion of the magnetic media may be allocated to one or more so-called “exception regions” (E-regions) which are used as staging areas for data which will ultimately be written to an I-region. The E-region is sometimes referred to as an E-cache. Since most of the data in an SMR drive is expected to be stored sequentially in I-regions, the data records that are not currently stored in the I-regions can be thought of as “exceptions” to sequential I-region storage. However, each E-region consumes a portion of data storage 12 such that there is less space available for I-regions.

Controller 8 may receive, from host 4 via interface 14, a request to write a data block to data storage 12 of hard drive 6. For instance, the data block may be an inode table. As such, controller 8 may receive a request from host 4 to write the inode table to data storage 12 of hard drive 6.

Techniques of this disclosure may enable controller 8 to determine a hinting value assigned to the data blocks by controller 8 based on hinting information. For instance, the hinting information may include one or more of a file type (determined by one of a file type code, a file name extension, or a file signature), a set of counter bits in a header of the data block, an amount of time since the data block was last accessed (which can be written in the header of the data block), an allocation type based on the operations of host 14 and controller 8, and a file size (which can also be written in the header of the data block). Based on one or more of pieces of hinting information, controller 8 may derive a hinting value. The hinting value may be represented by a set of bits appended to the corresponding data block, such as in a header of the data block. By implementing this interface in controller 8 of hard drive 6, there may be minimal changes to the commands issued by host 4. Further, for host aware versions of hard drive 6, because host aware hard drives may require minimal modification to implement the techniques described herein, the cost of implementing a system that utilizes these techniques may be less than the cost of implementing a system using conventional host aware techniques. These techniques may also provide the benefit of predictable operations, rather than the unpredictable nature of drive managed SMR HDDs and host aware SMR HDDs.

Controller 8 may determine a location of data storage 12 of hard drive 6 at which to write the data block based at least in part on the determined hinting value. The location may include one of the at least one random access zone or one of the at least one sequential access zone. For instance, system files, such as the inode table of the data block, may be accessed frequently and in varying orders. In this example, the location may include at least one random access zone. As such, the inode table may include a hinting value that indicates the inode table is to be written to the random access zone of data storage 12. Conversely, a file with a known media type may be larger files and modified with less frequency. As such, files with a known media type may have a hinting value that indicates the file should be written to a location of the at least one sequential access zone.

Controller 8 may write the date block to the location of data storage 12. For instance, controller 8 may write the inode table to the determined location of at least one random access zone of data storage 12 in hard drive 6.

By using a hinting value appended to the data blocks based on at least a file type to allocate data in data storage 12, controller 8 of hard drive 6 may predictably and efficiently allocate data blocks in the optimal location of data storage 12 based on how frequently the data block has been modified in the past or is likely to be modified in the future. As is recognized by the techniques of this disclosure, different files are best stored and accessed in different types of access zones (i.e., random or sequential) depending on the various characteristics of the file being written. By adding a hinting value to the data block, the data block can efficiently be allocated to the optimal portion of data storage 12 with a relatively small addition of extra data. For instance, in the instance described with respect to FIG. 1, as few as two bits may be added for an entire inode table. By implementing these techniques in controller 8, host 4 may undergo minimal changes to commands that host 4 may issue. Further, since host aware hard drives may require minimal modification to implement the techniques described herein, the cost of implementing a system that utilizes these techniques may be less than the cost of implementing a system using conventional host aware techniques. These techniques may also provide the benefit of predictable operations, rather than the unpredictable nature of drive managed SMR HDDs and host aware SMR HDDs.

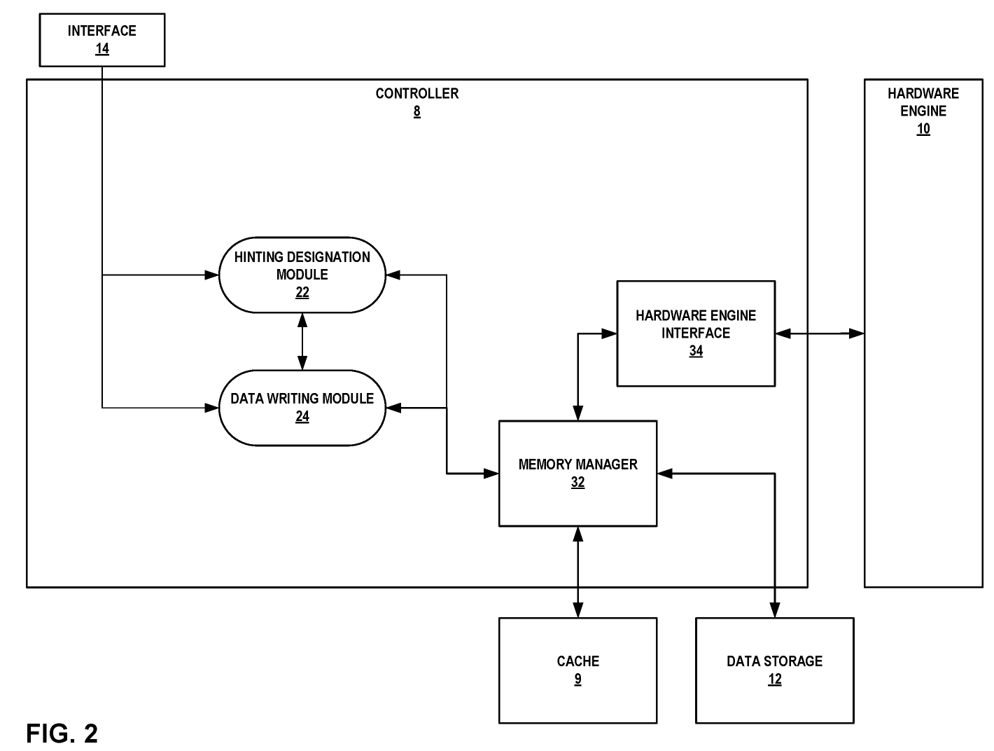

FIG. 2 is a block diagram illustrating controller 8 and other components of hard drive 6 of FIG. 1 in more detail. In the example of FIG. 2, controller 8 includes interface 14, hinting designation module 22, data writing module 24, memory manager unit 32, and hardware engine interface unit 34. Memory manager unit 32 and hardware engine interface unit 34 may perform various functions typical of a controller on a hard drive. For instance, hardware engine interface unit 34 may represent a unit configured to facilitate communications between the hardware controller 8 and the hardware engine 10. Hardware engine interface unit 34 may present a standardized or uniform way by which to interface with hardware engine 10. Hardware engine interface 34 may provide various configuration data and events to hardware engine 10, which may then process the event in accordance with the configuration data, returning various different types of information depending on the event. In the context of an event requesting that data be read (e.g., a read request), hardware engine 10 may return the data to hardware engine interface 34, which may pass the data to memory manager unit 32. Memory manager unit 32 may store the read data to cache 9 and return a pointer or other indication of where this read data is stored to hardware engine interface 34. In the context of an event involving a request to write data (e.g. a write request), hardware engine 10 may return an indication that the write has completed to hardware engine interface unit 34. In this respect, hardware engine interface unit 34 may provide a protocol and handshake mechanism with which to interface with hardware engine 10.

Controller 8 includes various modules, including hinting designation module 22 and data writing module 24. The various modules of controller 8 may be configured to perform various techniques of this disclosure, including the technique described above with respect to FIG. 1. Hinting designation module 22 and data writing module 24 may perform operations described herein using software, hardware, firmware, or a mixture of hardware, software, and firmware residing in and/or executing on hard drive 6.

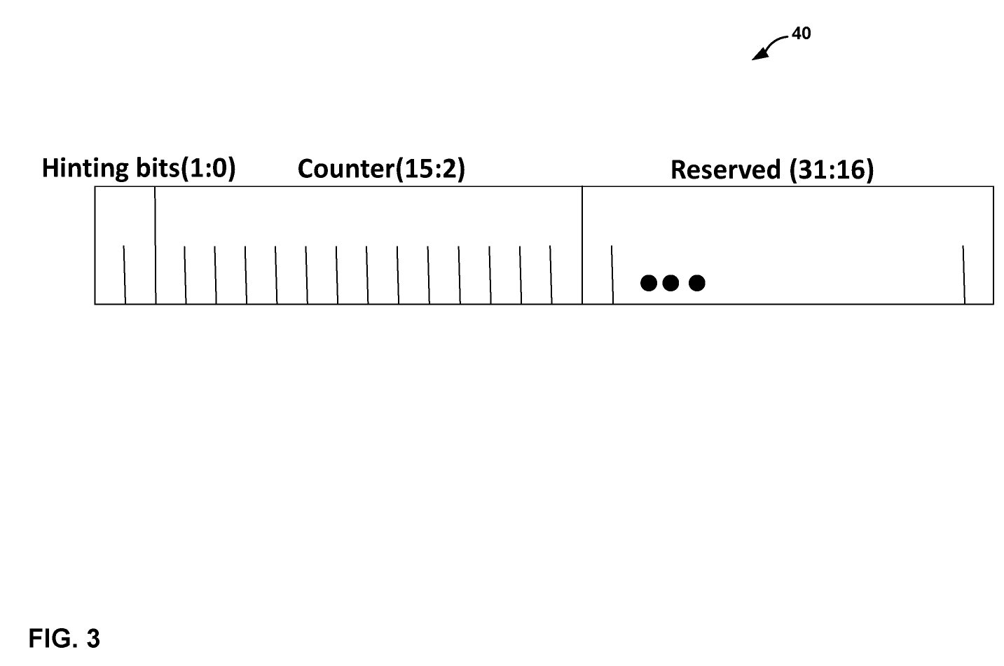

Using hinting designation module 22 and data writing module 24, controller 8 may perform techniques of this disclosure to partition and write data to data storage 12 of hard drive 6. Techniques of this disclosure may enable controller 8 to allocate data blocks in data storage 12 based on hinting information and a hinting value based on the hinting information. For instance, the hinting information may include one or more of a file type, a set of counter bits in the data block, an amount of time since the data block was last accessed, an allocation type, and a file size. As shown with respect to FIG. 3, the hinting value may be represented by a set of bits appended to the corresponding data block, such as in a header of the data block. By implementing this interface in controller 8 of hard drive 6, there may be minimal changes to the commands issued by host 4. Further, for host aware versions of hard drive 6, because host aware hard drives may require minimal modification to implement the techniques described herein, the cost of implementing a system that utilizes these techniques may be less than the cost of implementing a system using conventional host aware techniques. These techniques may also provide the benefit of more predictable operations, rather than the unpredictable nature of drive managed SMR HDDs and host aware SMR HDDs.

Data writing module 24 of controller 8 may receive, from host 4 via interface 14, a request to write a data block to data storage 12 of hard drive 6. For instance, the data block may be a jpg graphic file. As such, controller 8 may receive a request from host 4 to write the jpg graphic file to data storage 12 of hard drive 6.

Hinting designation module 22 of controller 8 may determine a hinting value for the data block based at least in part on hinting information associated with the data block. The hinting value may be represented by a set of hinting bits appended to the corresponding data block, such as in a header of the data block. The hinting information may be based at least in part on one or more of a file type, a set of counter bits in the data block, an amount of time since the data block was last accessed, an allocation type, and a file size. Based on the configuration of the data block as defined by the hinting information, hinting designation module 22 of controller 8 may determine the hinting value.

In some examples, hinting designation module 22 of controller 8 may write the determined hinting value to the set of hinting bits appended to the header of the data block. For instance, during an initial write of the jpg graphic file, the data block of the jpg graphic file may either include a header of two null bits, or the data block may not include the hinting bits. As such, hinting designation module 22 may set the value of the hinting bits to equal the hinting value. In some such examples, hinting designation module 22 may set the value of the hinting bits by adding the extra bits to the data block.

For instance, hinting designation module 22 of controller 8 may have four possible hinting values to choose from when determining where to allocate the jpg graphic file. In such an example, the hinting value may include a set of two hinting bits to be appended to a header of the data block by hinting designation module 22 of controller 8. A first hinting value (e.g., hinting bits 00) may be used for system files. For example, the hinting bits 00 may be appended to a data block that is a system file, such as system metadata, an inode table, directory data, journal data, a logical block address mapping table, or a zone mapping table. A second hinting value (e.g., hinting bits 11) may be appended for files with a known media type, such as files with the extension .jpeg, .mpeg, .jpg, .bmp, .png, .mp4, .mp3, etc. The file type may be determined using at least one of a file signature, a file name extension, or a file type code. A third hinting value (e.g., hinting bits 01) may be appended for files with an unknown media type that are not system files. In other words, anything that is not assigned the hinting bits of 00 or 11 may be initially assigned the hinting bits 01.

In some examples, hinting designation module 22 may further append a set of one or more counter bits to the data block. Controller 8 may then monitor the access to that data block. If the data block is not updated for a certain period of time, hinting designation module 22 of controller 8 may alter the hinting bits for the data block from 01 to 11.

Conversely, if the data block is accessed many times, hinting designation module 22 of controller 8 may alter the hinting bits to a fourth hinting value (e.g. hinting bits 10). In determining whether the data block has been accessed “many times,” hinting designation module 22 may utilize the set of counter bits that hinting designation module 22 appended to the data block. Each time memory manager 32 accesses the data block, hinting designation module 22 of controller 8 may increase a value equivalent of the set of counter bits by one. When each bit in the set of counter bits for the data block is equal to 1, hinting designation module 22 of controller 8 may modify the hinting bits of the data block to equal the fourth hinting value.

Because the jpg graphic file is a file with a known media type, hinting designation module 22 of controller 8 may determine that the hinting value should be represented by hinting bits 11. It should be noted that, while the above example utilizes four possible hinting values using two hinting bits, the techniques of this disclosure may be utilized with more than four possible hinting values or less than four possible hinting values.

Data writing module 24 of controller 8 may determine a location of data storage 12 of hard drive 6 at which to write the data block based at least in part on the hinting value. The location may include one of the at least one random access zone or one of the at least one sequential access zone. For instance, with the jpg graphic file, controller 8 may access the file in the same way and in a sequential order. As such, files with a known media type may be accessed most efficiently when written to a location of at least one sequential access zone. Therefore, the hinting value (i.e., hinting bits equal to 11) may indicate that the file should be written to a sequential access zone.

In other instance, system files, such as the inode table described with respect to FIG. 1, may be accessed frequently and in varying orders. In such an example, the file may be accessed most efficiently when written to a location of at least one random access zone. As such, a system file may include a hinting value of 00 that indicates data writing module 24 is to write the system file to the random access zone of data storage 12.

In still other instances, such as when the data block has an unknown media type, data writing module 24 may need more information before determining the most efficient location at which to write the data block. Since data storage 12 of hard drive 6 typically has a larger portion designated to sequential access rather than random access, data writing module 24 may initially write a data block with the hinting value of 01 to a location in a sequential access zone. If the file is not accessed for a predetermined period of time and hinting designation module 22 updated the hinting bits to be equal to 11, hinting designation module 22 may classify the data block as a cold data block. Cold data blocks may be most efficiently stored in the sequential access zone, as access to the cold data blocks is limited. In such an instance, data writing module 24 may determine to keep the data block in the sequential access zone. In other instances, such as when hinting designation module 22 updates the hinting bits to be equal to 10 based on the increments performed on the set of counter bits, data writing module 24 may determine that the unknown media file is accessed frequently enough that it is more efficient to store the data block in a random access zone. As such, responsive to hinting designation module 22 updating the hinting bits, data writing module 24 may move the data block from the sequential access zone to the random access zone.

Data writing module 24 of controller 8 may write the date block to the location of data storage 12. For instance, data writing module 24 of controller 8 may write the jpg graphic file to the determined location of at least one sequential access zone of data storage 12 in hard drive 6.

Other configurations defined by the hinting information may define what hinting value should be assigned to a particular data block. For instance, the hinting information may include a file size. Files above a certain size may be more efficiently accessed in a sequential access zone rather than a random access zone. As such, when the file size of a data block is greater than a predefined size (e.g., 16 KB), hinting designation module 22 may assign the data block a hinting value that indicates data writing module 24 is to write the data block in a sequential access zone.

In other instances, the hinting information may include an allocation type. For example, when controller 8 uses persistent pre-allocation, memory manager 32 pre-allocates on-disk space for a file. To do this on most file systems, zeros would be written to the file when created. The allocated space would be guaranteed and likely contiguous. As such, it would be generally inefficient to guarantee contiguous space in a random access zone, as finding such contiguous space may be troublesome and require defragmentation. Therefore, when persistent pre-allocation is used, hinting designation module 22 may assign the data block a hinting value that indicates data writing module 24 is to write the data block in a sequential access zone.

By using a hinting value appended to the data blocks based on at least a file type to allocate data in data storage 12, controller 8 of hard drive 6 may predictably and efficiently allocate data blocks in the optimal location of data storage 12 based on how the data block is likely to be accessed in the future. As is recognized by the techniques of this disclosure, different files are best stored and accessed in different types of access zones (i.e., random or sequential) depending on the type of file being stored and accessed. By adding a hinting value to the data block, the data block can efficiently be allocated to the optimal portion of data storage 12 with a relatively small addition of extra data. For instance, in the instance described with respect to FIG. 2, as few as only two bits may be added for an entire jpg graphic file, though extra bits (e.g., 1-30 bits) may be incorporated to utilize the function of the counter bits. By implementing these techniques in controller 8, host 4 may undergo minimal changes to commands that host 4 may issue. Further, host aware versions of hard drive 6, because host aware hard drives may require minimal modification to implement the techniques described herein, the cost of implementing a system that utilizes these techniques may be less than the cost of implementing a system using conventional host aware techniques. These techniques may also provide the benefit of predictable operations, rather than the unpredictable nature of drive managed SMR HDDs and host aware SMR HDDs.

FIG. 3 is a conceptual diagram illustrating an example addition to a data block 40 to be written to hard drive 6, in accordance with one or more techniques of this disclosure. In utilizing techniques of the current disclosure, controller 8 may append one or more hinting bits to a data block. Based on the hinting information, controller 8 may define the values of the bits in the hinting bits.

For instance, as shown in FIG. 3, controller 8 may add 2 hinting bits to a header of the data block. As such, controller 8 may have four possible hinting values to choose from when determining where to allocate the data block. A first hinting value (e.g., hinting bits 00) may be used for system files. For example, the hinting bits 00 may be appended to a data block that is a system file, such as system metadata, an inode table, directory data, journal data, a logical block address mapping table, or a zone mapping table. A second hinting value (e.g., hinting bits 11) may be appended for files with a known media type, such as files with the extension .jpeg, .mpeg, .jpg, .bmp, .png, .mp4, .mp3, etc. Since these files, regardless of access frequency, are generally larger files that are only read, rather than altered and requiring a rewrite, these files may be more efficiently placed in the sequential access zones. The file type may be determined using at least one of a file signature, a file name extension, or a file type code. A third hinting value (e.g., hinting bits 01) may be appended for files with an unknown media type that are not system files. In other words, anything that is not assigned the hinting bits of 00 or 11 may be initially assigned the hinting bits 01.

Further, as shown in FIG. 3, controller 8 may further append counter bits to the header of the data block. In the example of FIG. 3, controller 8 may append 14 counter bits to the header of the data block. Controller 8 may then monitor the access to that data block. If the data block is not updated for a certain period of time, hinting designation module 22 of controller 8 may alter the hinting bits for the data block from 01 to 11.

Conversely, if the data block is accessed many times, controller 8 may alter the hinting bits to a fourth hinting value (e.g. hinting bits 10). In determining whether the data block has been accessed “many times,” controller 8 may utilize the set of counter bits appended to the data block. Each time controller 8 accesses the data block, hinting controller 8 may increase a value equivalent of the set of counter bits by one. When each bit in the set of counter bits for the data block is equal to 1, controller 8 may modify the hinting bits of the data block to equal the fourth hinting value. In the example of FIG. 3, using 14 counter bits, controller 8 may update the hinting bits to equal 10 when the data block is accessed 16,384 times (the value of 14 counter bits). In other instances, rather than updating the value equivalent of the counter bits, controller 8 may simply change one of the counter bits to equal 1 upon accessing the data block. In such instances, controller 8 may update the hinting bits to equal 10 when the data block is accessed 14 times (one for each of the 14 counter bits). In some examples, even if each bit in the set of counter bits is equal to 1, controller 8 may not access the file for an extended period of time. If the file is not accessed for a predetermined period of time, controller 8 may change the hinting bits from 10 to 11, thereby moving the data block from the random access zone to the sequential access zone.

Controller 8 may further include other instructions typically found in a header in the added bits to the data block. Such information may include the file size, the file resolution, a signature, declared functions, a syncword, IP addresses, or time stamps.

As shown in the example of FIG. 3, in order to utilize the techniques described herein, an entire file may be handled with the addition of only 16 extra bits. With file sizes being measured in kilobytes, megabytes, gigabytes, or even terabytes, adding only 16 extra bits minimizes the encumbrances of adding data to each file written to hard drive 6.

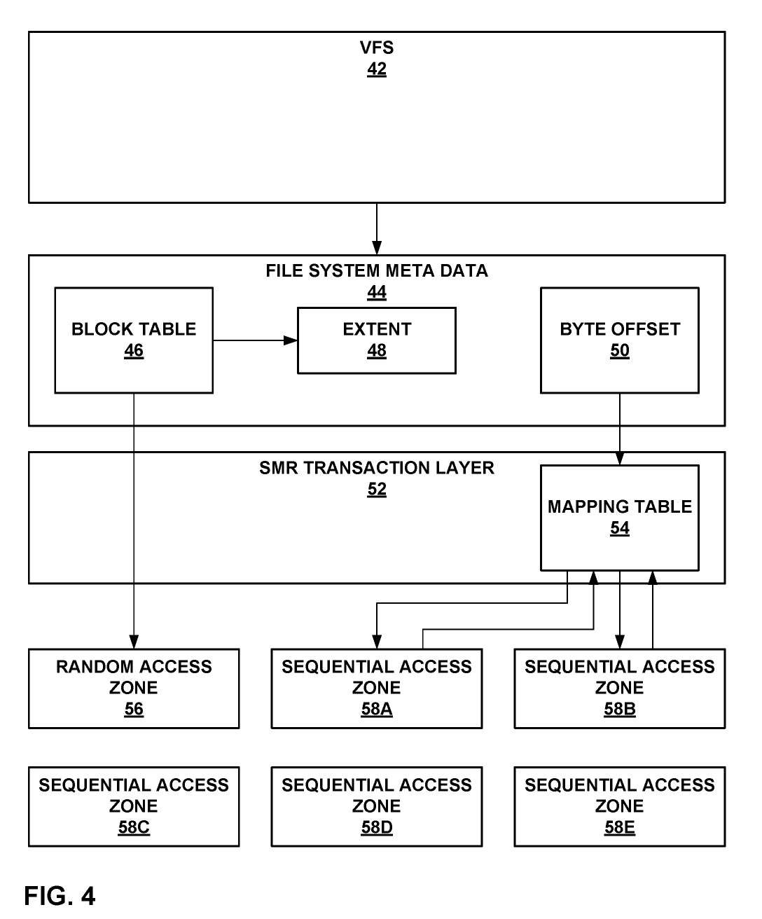

FIG. 4 is a conceptual and schematic block diagram illustrating an example software/hardware structure of hard drive 6, in accordance with one or more techniques of this disclosure. In the example of FIG. 4, hard disk drive includes virtual file system (VFS) 42, file system meta data 44, shingled magnetic recording (SMR) transaction layer 52, and the data storage zones 56 and 58A-58E.

In general, file system metadata 44 includes information about a file, e.g., user identification of who owns it, permissions, file type (special, regular, named pipe, etc.) and which disk-blocks the file uses. File system metadata 44 may also be known as an inode table. File system meta data 44 may include block table 46, extent 48, and byte offset 50. Block table 46 may track the location of each block stored in any of zones 56 and 58A-58E. Block table 46 itself may be stored in random access zone 56.

Extent 48 may be a contiguous area of storage reserved for a file in a file system, represented as a range. A file can consist of zero or more extents 48, where one file fragment requires one extent. The direct benefit of extent 48 is in storing each range compactly as two numbers, instead of canonically storing every block number in the range. In accordance with the techniques described herein, extent 48 may apply new file allocation using the hinting values.

Byte offset 50 may be used when reading data from one of zones 56 or 58A-58E. For instance, when a file is not accessed sequentially, whether it is written to random access zone 56 or one of sequential access zones 58A-58E, VFS 42 may access the requested file using byte offset 50.

File system metadata 44 may be part of an SMR friendly file system. As such, file system metadata 44 may be configured to exhibit aware SMR behavior without explicitly utilizing SMR mechanisms such as logical block address mapping and garbage collecting.

SMR transaction layer 52 may be configured to form packet contents with information obtained from VFS 42. SMR transaction layer 52, in contrast with file system metadata 44, may be configured to utilize the SMR mechanisms such as logical block address mapping and garbage collecting. SMR transaction layer 52 may utilize mapping table 54 to determine specific portions of zones 56 or 58A-58E at which to write the data blocks transmitted by VFS 42.

VFS 42 may include an abstraction layer on top of the more concrete file system defined by the data storage zones 56 and 58A-58E. Examples of VFS 42 include ext2, ext3, ext3, XFS, and ext4. The purpose of VFS 42 is to allow client applications to access different types of concrete file systems in a uniform way.

As VFS 42 is used as the interface between a host client application accessing the data and the data itself, techniques of this disclosure may be implemented within VFS 42. VFS 42 may be configured to receive information from a host that may or may not be aware of SMR procedures. Utilizing the techniques of this disclosure, VFS 42 may determine the optimal location at which to write the received data blocks and instruct SMR transaction layer 52, which utilizes SMR functions, as to which type of zone SMR transaction layer 52 should write the received data.

In accordance with techniques of this disclosure, VFS 42 may receive a request to write a data block to one of zones 56 or 58A-58E. VFS 42 may determine a hinting value for the data block based on hinting information of the data block. VFS 42 may further determine, based at least in part on the hinting value, which of zones 56 or 58A-58E to write the data block. VFS 42 may then instruct SMR transaction layer 52 to write the data block to the determined one of zones 56 or 58A-58E using file system metadata 44.

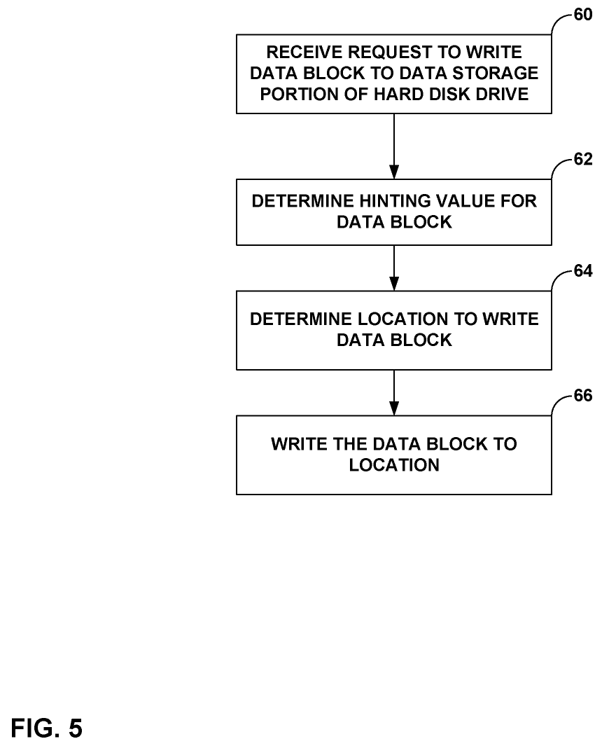

FIG. 5 is a flow diagram illustrating an exemplary operation of a storage device controller in performing various aspects of the data allocation techniques described in this disclosure. For the purposes of illustration only, reference will be made to structures of FIG. 1 in describing the functionality performed in accordance with the techniques of this disclosure.

Controller 8 may receive, from host 4 via interface 14, a request to write a data block to data storage 12 of hard drive 6 (60). For instance, the data block may be a file with an unknown media type. As such, controller 8 may receive a request from host 4 to write the unknown media file to data storage 12 of hard drive 6.

Controller 8 may determine a hinting value for the data block based at least in part on hinting information associated with the data block (62). The hinting value may be represented by a set of hinting bits appended to the corresponding data block, such as in a header of the data block. The hinting information may be based at least in part on one or more of a file type, a set of counter bits in the data block, an amount of time since the data block was last accessed, an allocation type, and a file size. Based on the configuration of the data block as defined by the hinting information, controller 8 may determine the hinting value.

In some examples, controller 8 may write the determined hinting value to the set of hinting bits appended to the header of the data block. For instance, during an initial write of the unknown media file, the data block of the jpg graphic file may either include a header of two null bits, or the data block may not include the hinting bits. As such, controller 8 may set the value of the hinting bits to equal the hinting value. In some such examples, controller 8 may set the value of the hinting bits by adding the extra bits to the data block.

For instance, controller 8 may have four possible hinting values to choose from when determining where to allocate the unknown media file. In such an example, the hinting value may include a set of two hinting bits to be appended to a header of the data block by controller 8. A first hinting value (e.g., hinting bits 00) may be used for system files. For example, the hinting bits 00 may be appended to a data block that is a system file, such as system metadata, an mode table, directory data, journal data, a logical block address mapping table, or a zone mapping table. A second hinting value (e.g., hinting bits 11) may be appended for files with a known media type, such as files with the extension .jpeg, .mpeg, .jpg, .bmp, .png, .mp4, .mp3, etc. The file type may be determined using at least one of a file signature, a file name extension, or a file type code. A third hinting value (e.g., hinting bits 01) may be appended for files with an unknown media type that are not system files. In other words, anything that is not assigned the hinting bits of 00 or 11 may be initially assigned the hinting bits 01.

In some examples, controller 8 may further append a set of one or more counter bits to the data block. Controller 8 may then monitor the access to that data block. If the data block is not updated for a certain period of time, controller 8 may alter the hinting bits for the data block from 01 to 11.

Conversely, if the data block is accessed many times, controller 8 may alter the hinting bits to a fourth hinting value (e.g. hinting bits 10). In determining whether the data block has been accessed “many times,” controller 8 may utilize the set of counter bits that controller 8 appended to the data block. Each time controller 8 accesses the data block, controller 8 may increase a value equivalent of the set of counter bits by one. When each bit in the set of counter bits for the data block is equal to 1, controller 8 may modify the hinting bits of the data block to equal the fourth hinting value.

Because the unknown media file is a file with an unknown media type, controller 8 may determine that the hinting value should be represented by hinting bits 01. In other instances, if controller 8 determines that the data block may be accessed more often than a general file, controller 8 may determine the hinting value should be represented by hinting bits 10, placing the data block in the random access zone. It should be noted that, while the above example utilizes four possible hinting values using two hinting bits, the techniques of this disclosure may be utilized with more than four possible hinting values or less than four possible hinting values.

Controller 8 may determine a location of data storage 12 of hard drive 6 at which to write the data block based at least in part on the hinting value (64). The location may include one of the at least one random access zone or one of the at least one sequential access zone.

For instance, since the data block has an unknown media type, controller 8 may need more information before determining the most efficient location at which to write the data block. Since data storage 12 of hard drive 6 typically has a larger portion designated to sequential access rather than random access, controller 8 may initially write the data block with the hinting value of 01 to a location in a sequential access zone. If the file is not accessed for a predetermined period of time and controller 8 updated the hinting bits to be equal to 11, controller 8 may classify the data block as a cold data block. Cold data blocks may be most efficiently stored in the sequential access zone, as access to the cold data blocks is limited. In such an instance, controller 8 may determine to keep the data block in the sequential access zone. In other instances, such as when controller 8 updates the hinting bits to be equal to 10 based on the increments performed on the set of counter bits, controller 8 may determine that the unknown media file is accessed frequently enough that it is more efficient to store the data block in a random access zone. As such, responsive to controller 8 updating the hinting bits, controller 8 may move the data block from the sequential access zone to the random access zone.

In other instances, system files, such as the inode table described with respect to FIG. 1, may be accessed frequently and in varying orders. In such an example, the file may be accessed most efficiently when written to a location of at least one random access zone. As such, a system file may include a hinting value of 00 that indicates controller 8 is to write the system file to the random access zone of data storage 12.

In other instances, such as the jpg graphic file of FIG. 2, controller 8 may access the file in the same way and in a sequential order. As such, files with a known media type may be accessed most efficiently when written to a location of at least one sequential access zone. Therefore, the hinting value (i.e., hinting bits equal to 11) may indicate that the file should be written to a sequential access zone. For instance, with the jpg graphic file, controller 8 may access the file in the same way and in a sequential order. As such, files with a known media type may be accessed most efficiently when written to a location of at least one sequential access zone. Therefore, the hinting value (i.e., hinting bits equal to 11) may indicate that the file should be written to a sequential access zone of data storage 12.

Controller 8 may write the date block to the location of data storage 12 (66). For instance, controller 8 may write the unknown media file to the determined location of at least one sequential access zone of data storage 12 in hard drive 6.

Other configurations defined by the hinting information may define what hinting value should be assigned to a particular data block. For instance, the hinting information may include a file size. Files above a certain size may be more efficiently accessed in a sequential access zone rather than a random access zone. As such, when the file size of a data block is greater than a predefined size (e.g., 16 KB), controller 8 may assign the data block a hinting value that indicates controller 8 is to write the data block in a sequential access zone.

In other instances, the hinting information may include an allocation type. For example, when controller 8 uses persistent pre-allocation, controller 8 pre-allocates on-disk space for a file. To do this on most file systems, zeros would be written to the file when created. The allocated space would be guaranteed and likely contiguous. As such, it would be generally inefficient to guarantee contiguous space in a random access zone, as finding such contiguous space may be troublesome and require defragmentation. Therefore, when persistent pre-allocation is used, controller 8 may assign the data block a hinting value that indicates controller 8 is to write the data block in a sequential access zone.

By using a hinting value appended to the data blocks based on at least a file type to allocate data in data storage 12, controller 8 of hard drive 6 may predictably and efficiently allocate data blocks in the optimal location of data storage 12 based on how the data block is likely to be accessed in the future. As is recognized by the techniques of this disclosure, different files are best stored and accessed in different types of access zones (i.e., random or sequential) depending on the type of file being stored and accessed. By adding a hinting value to the data block, the data block can efficiently be allocated to the optimal portion of data storage 12 with a relatively small addition of extra data. For instance, in the instance described with respect to FIG. 5, as few as only two bits may be added for an entire media file, though extra bits (e.g., 1-30 bits) may be incorporated to utilize the function of the counter bits. By implementing these techniques in controller 8, host 4 may undergo minimal changes to commands that host 4 may issue. Further, host aware versions of hard drive 6, because host aware hard drives may require minimal modification to implement the techniques described herein, the cost of implementing a system that utilizes these techniques may be less than the cost of implementing a system using conventional host aware techniques. These techniques may also provide the benefit of predictable operations, rather than the unpredictable nature of drive managed SMR HDDs and host aware SMR HDDs.

The techniques described in this disclosure may be implemented, at least in part, in hardware, software, firmware, or any combination thereof. For example, various aspects of the described techniques may be implemented within one or more processing units, including one or more microprocessing units, digital signal processing units (DSPs), application specific integrated circuits (ASICs), field programmable gate arrays (FPGAs), or any other equivalent integrated or discrete logic circuitry, as well as any combinations of such components. The term “processing unit” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processing units, or other processing units, to implement one or more of the techniques described herein, such as when instructions included or encoded in the computer-readable storage medium are executed by the one or more processing units. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disk ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

1. A method comprising:
receiving, by a controller of a hard disk drive, a request to write a data block to a data storage platter of the hard disk drive, wherein the data storage platter includes at least one random access zone and at least one sequential access zone;
determining, by the controller and based on hinting information of the data block, a hinting value for the data block;
determining, by the controller and based at least in part on the hinting value, a location of the data storage platter of the hard disk drive at which to write the data block, wherein the location includes one of the at least one random access zone or one of the at least one sequential access zone; and
writing, by the controller, the data block at the location.

2. The method of claim 1, wherein the hinting information comprises at least one of a file type, a set of counter bits in the data block, an amount of time since the data block was last accessed, an allocation type, and a file size.

3. The method of claim 2, wherein the hinting information includes the set of counter bits in the data block, wherein the set of counter bits in the data block indicate a number of accesses made to the data block by the controller, and wherein the location includes one of the at least one sequential access zone, the method further comprising:
moving, by the controller, the data block from the one of the at least one sequence access zone to at least one of the at least one random access zone based on the set of counter bits.

4. The method of claim 3, further comprising:
incrementing, by the controller, a value of the set of counter bits each time the controller accesses the data block;
responsive to determining that each bit in the set of counter bits is equal to 1, moving, by the controller, the data block from the sequential access zone to the random access zone; and
updating, by the controller, the hinting value to indicate an updated location of the data storage platter of the hard disk drive at which the data block is written.

5. The method of claim 2, wherein the hinting information includes the amount of time since the data block was last accessed, the method further comprising:
determining, by the controller, the amount of time since the data block was last accessed is greater than a predetermined amount of time; and
determining, by the controller, the hinting value to indicate the location at which to write the data block is one of the at least one sequential access zone .

6. The method of claim 2, wherein the hinting information includes the file type, the method further comprising:
determining, by the controller, the file type comprises a known media file extension; and
determining, by the controller, the hinting value to indicate the location at which to write the data block is one of the at least one sequential access zone.

7. The method of claim 2, wherein the hinting information includes the file size, the method further comprising:
determining, by the controller, the file size is greater than a predefined size; and
determining, by the controller, the hinting value to indicate the location at which to write the data block is one of the at least one sequential access zone.

8. The method of claim 2, wherein the hinting information includes the allocation type, the method further comprising:
determining, by the controller, the allocation type is a persistent preallocation; and
determining, by the controller, the hinting value to indicate the location at which to write the data block is one of the at least one sequential access zone.

9. The method of claim 2, wherein the hinting information includes the file type, the method further comprising:
determining, by the controller, the file type based at least in part on one of a file signature, a file name extension, or a file type code.

10. The method of claim 1, wherein the hinting information includes the file type, the method further comprising:
determining, by the controller, the file type is one of a system file, an inode table, directory data, journal data, a logical block address mapping table, or a zone mapping table; and
determining, by the controller, the hinting value to indicate the location at which to write the data block is one of the at least one random access zone.

11. The method of claim 1, wherein the hard disk drive comprises a virtual file system, a shingled magnetic recording-friendly file system, and a shingled magnetic recording transaction layer.

12. A hard disk drive comprising:
a data storage platter including at least one random access zone and at least one sequential access zone; and
a controller configured to:
receive a request to write a data block to the data storage platter of the hard disk drive;
determine, based on hinting information of the data block, a hinting value for the data block;
determine, based at least in part on the hinting value, a location of the data storage platter of the hard disk drive at which to write the data block, wherein the location includes one of the at least one random access zone or one of the at least one sequential access zone; and
write the data block at the location.

13. The hard disk drive of claim 12, wherein the hinting information comprises at least one of a file type, a set of counter bits in the data block, an amount of time since the data block was last accessed, an allocation type, and a file size.

14. The hard disk drive of claim 13, wherein the hinting information includes the set of counter bits in the data block, wherein the set of counter bits in the data block indicate a number of accesses made to the data block by the controller, and wherein the location includes one of the at least one sequential access zone, and wherein the controller is further configured to:
increment a value of the set of counter bits each time the controller accesses the data block;
move the data block from the one of the at least one sequential access zone to at least one of the at least one random access zone based on the set of counter bits, wherein the controller moves the data block from the sequential access zone to the random access zone when each bit in the set of counter bits is equal to 1; and
update the hinting value to indicate an updated location of the data storage platter of the hard disk drive at which the data block is written.

15. The hard disk drive of claim 13, wherein the hinting information includes the amount of time since the data block was last accessed, and wherein the controller is further configured to:
determine the amount of time since the data block was last accessed is greater than a predetermined amount of time; and
determine the hinting value to indicate the location at which to write the data block is one of the at least one sequential access zone.

16. The hard disk drive of claim 13, wherein the hinting information includes the allocation type, wherein the controller is further configured to:
determine the allocation type is a persistent preallocation; and
determine the hinting value to indicate the location at which to write the data block is one of the at least one sequential access zone.

17. The hard disk drive of claim 13, wherein the hinting information includes the file type, wherein the controller is further configured to:
determine the file type based at least in part on one of a magic number, a file name extension, or a file type code.

18. The hard disk drive of claim 13, wherein the controller is further configured to:
determine the hinting value to indicate the location at which to write the data block is one of the at least one random access zone responsive to determining the file type comprises one of a system file, an mode table, directory data, journal data, a logical block address mapping table, or a zone mapping table; and
determine the hinting value to indicate the location at which to write the data block is one of the at least one sequential access zone responsive to determining the file type comprises a known media file extension.

19. The hard disk drive of claim 12, wherein the hard disk drive comprises a virtual file system, a shingled magnetic recording-friendly file system, and a shingled magnetic recording transaction layer.

20. A computer-readable storage medium comprising instructions that, when executed, cause a controller of a hard disk drive to:
receive a request to write a data block to a data storage platter of the hard disk drive, wherein the data storage platter includes at least one random access zone and at least one sequential access zone;
determine, based on hinting information of the data block, a hinting value for the data block;
determine, based at least in part on the hinting value, a location of the data storage platter of the hard disk at which to write the data block, wherein the location includes one of the at least one random access zone or one of the at least one sequential access zone; and
write the data block at the location.
